(19) United States
(12) Patent Application Publication
(10) Pub. No.: US 2026/0242140 A1
(43) Pub. Date: Aug. 20, 2026

(54) METHOD FOR STORING BATTERY CELL

(71) Applicant: SK On Co., Ltd., Seoul (KR)

(72) Inventors: Soo Ho CHO, Daejeon (KR); Kang Hyuk CHOI, Daejeon (KR)

(21) Appl. No.: 19/545,023

(22) Filed: Feb. 20, 2026

(30) Foreign Application Priority Data
Feb. 20, 2025 (KR) 10-2025-0022015

(51) Int. Cl. B65G 1/06; B65G 1/137

(52) U.S. Cl. CPC B65G 1/065; B65G 1/1371

(57) ABSTRACT

The present disclosure relates to a method for storing a battery cell. A method for storing a battery cell includes: determining that a battery cell to be stored has arrived from a distribution conveyor; transferring the arrived battery cell to a plurality of moorages arranged between each of the plurality of lanes and the distribution conveyor, and loading the battery cell; searching for a location of the battery cell being stored in the storage and an non-storage location; selecting, from the non-storage location, an intended storage location having a maximum movement distance along rows and columns of a transfer car for transferring the battery cell; and transferring the battery cell from the moorages to the intended storage location by the transfer car, and storing the battery cell.

### CROSS-REFERENCE TO RELATED PATENT APPLICATION

The present application claims priority under 35 U.S.C. § 119(a) to Korean patent application number 10-2025-0022015 filed on February 20, 2025, in the Ministry of Intellectual Property, the entire disclosure of which is incorporated by reference herein.

### BACKGROUND OF THE INVENTION

### Field

The disclosure relates to a method for storing a battery cell during an aging process of the battery cell.

### Description of the Related Art

A lithium secondary battery is composed of an electrode assembly having a porous separator between a positive electrode and a negative electrode, each of which has an active material applied to an electrode collector, and is impregnated with a non-aqueous electrolyte containing lithium salts.

After manufacturing, these secondary batteries are subjected to an aging process to remove gases generated by charging and discharging.

This process involves storing cells and shipping them out after a certain period of time, and if there are multiple storage areas in a single aging room, it is important to select the most efficient location and avoid reducing the utilization rate of the receiving facility.

### SUMMARY OF THE INVENTION

According to an aspect of the present disclosure, the disclosure is to improve the manufacturing efficiency of battery cells.

According to another aspect of the disclosure, the flow impact of a distribution conveyor can be minimized.

According to another aspect of the present disclosure, the cell loading rate of a storage can be efficiently managed.

According to another aspect of the present disclosure, a distribution conveyor can be prevented from stopping or generating errors.

Meanwhile, a method for storing a battery cell according to the present disclosure can be widely applied in the field of green technology such as electric vehicles, battery charging stations, energy storage systems (ESS), photovoltaics, wind power, and other fields that utilize battery cells. In addition, a method for storing a battery cell according to the present disclosure can be used in eco-friendly mobility, including electric vehicles and hybrid vehicles to prevent climate change by suppressing air pollution and greenhouse fluid emissions.

The present disclosure may provide a method for storing a battery cell, which is a method for storing the battery cell during an aging process of a battery cell, the method including: determining that a battery cell to be stored has arrived from a distribution conveyor carrying battery cells to a plurality of storages for storing the battery cell, the storages being arranged in rows and columns to form a plurality of lanes, respectively; transferring the arrived battery cell to a plurality of moorages arranged between each of the plurality of lanes and the distribution conveyor, and loading the battery cell; searching for a location of the battery cell being stored in the storage and an non-storage location; selecting, from the non-storage location, an intended storage location having a maximum movement distance along rows and columns of a transfer car for transferring the battery cell; and transferring the battery cell from the moorages to the intended storage location by the transfer car, and storing the battery cell.

In an embodiment, the selecting of the location having the maximum movement distance may be selection with the condition that the sum of the number of rows and the number of columns of each storage is the maximum value.

In an embodiment, the method may further include determining whether the number of battery cells moored in a first moorage closest to the arrived battery cell among the plurality of moorages is moored to saturation.

In an embodiment, the method may further include, if the number of battery cells in the first moorage is saturated, transferring the battery cell to a second moorage that is next closest to the arrived battery cells.

In an embodiment, the determining that the mooring is saturated may make a determination of 95% or more compared to the total number of battery cells that can be moored in the first moorage.

In an embodiment, if all of the moorages are determined to be moored to saturation, the distribution conveyor may stop for a predetermined period of time and it may be re-determined whether the plurality of moorages are moored to saturation.

In an embodiment, the method may further include, if the re-determination of whether the plurality of moorages are moored to saturation is determined as mooring saturation, circulating the arrived battery cell on the distribution conveyor without transferring the arrived battery cell from the distribution conveyor to the plurality of moorages.

In an embodiment, the transfer car may be moved by an operation in the horizontal and vertical directions.

In an embodiment, between the plurality of moorages and the plurality of lanes, a plurality of lift devices and a plurality of additional moorages may be further arranged.

In an embodiment, the arrived battery cell may be transferred in the order of the moorage, the lift device, the additional moorage, and the transfer car, and may be transferred to the intended storage location of the storage and stored therein.

In an embodiment, the determining that the mooring is saturated may be 95% or more of the total number of battery cells that can be moored in the plurality of moorages and the plurality of additional moorages.

In an embodiment, if both the plurality of moorages and the plurality of additional moorages are determined to be moored to saturation, the distribution conveyor may stop for a predetermined period of time and it may be re-determined whether the plurality of moorages and the plurality of additional moorages are moored to saturation.

In an embodiment, the method may further include, if the re-determination of whether the plurality of moorages and the plurality of additional moorages are moored to saturation is determined as mooring saturation, circulating the arrived battery cell on the distribution conveyor without transferring the arrived battery cell from the distribution conveyor to the plurality of moorages.

In an embodiment, the transfer car may be moved by an operation in the horizontal direction.

In an embodiment, the method may further include determining whether the plurality of storages are storage-saturated, wherein if all of the plurality of storages are determined to be storage-saturated, the distribution conveyor stops and waits for a predetermined period of time and it is re-determined whether the plurality of storages are storage-saturated.

In an embodiment, the determining of the storage saturation may make a determination of 95% or more compared to the total number of battery cells that can be stored in the plurality of storages.

In an embodiment, the method may further include, if the re-determination of whether the plurality of storages are saturated is determined as saturation, circulating the arrived battery cell on the distribution conveyor without transferring the arrived battery cell from the distribution conveyor to the plurality of moorages.

According to an embodiment of the present disclosure, the manufacturing efficiency of battery cells can be improved.

According to another embodiment of the disclosure, the flow impact of a distribution conveyor can be minimized.

According to another embodiment of the present disclosure, the cell loading rate of a storage can be efficiently managed.

According to another embodiment of the present disclosure, a distribution conveyor can be prevented from stopping or generating errors.

### BRIEF DESCRIPTION OF THE DRAWINGS

FIG. 1 is a schematic view of a warehouse system for implementing a method for storing a battery cell according to an embodiment of the present disclosure.

FIG. 2 is a flowchart illustrating the configuration of a method for storing a battery cell according to an embodiment of the present disclosure.

FIG. 3 is a schematic view illustrating the steps of creating a storage area in a storage in which a method for storing a battery cell according to an embodiment of the present disclosure is implemented, and of selecting an intended storage location.

FIGS. 4A to 4D are each a schematic view illustrating a battery cell transfer process for implementing a method for storing a battery cell according to an embodiment of the present disclosure.

FIG. 5 is a schematic view of a warehouse system for implementing a method for storing a battery cell according to another embodiment of the present disclosure.

FIG. 6 is a flowchart illustrating the configuration of a method for storing a battery cell according to another embodiment of the present disclosure.

FIGS. 7A to 7D are each a schematic view for explaining a transfer process of a battery cell in which a method for storing a battery cell according to another embodiment of the present disclosure is implemented.

### DETAILED DESCRIPTION

Below, with reference to the accompanying drawings, embodiments of the present disclosure will be described in detail to facilitate easy implementation by those skilled in the art. However, the present disclosure may be implemented in various different forms and is not limited to the embodiments described herein. For clarity in the drawings, portions unrelated to the description are omitted, and similar reference numerals are used throughout the specification.

Meanwhile, in the present disclosure, a battery cell includes a battery, a secondary battery, or a battery cell.

Hereinafter, a battery cell storage method according to various embodiments of the present disclosure will be described in more detail with reference to the drawings.

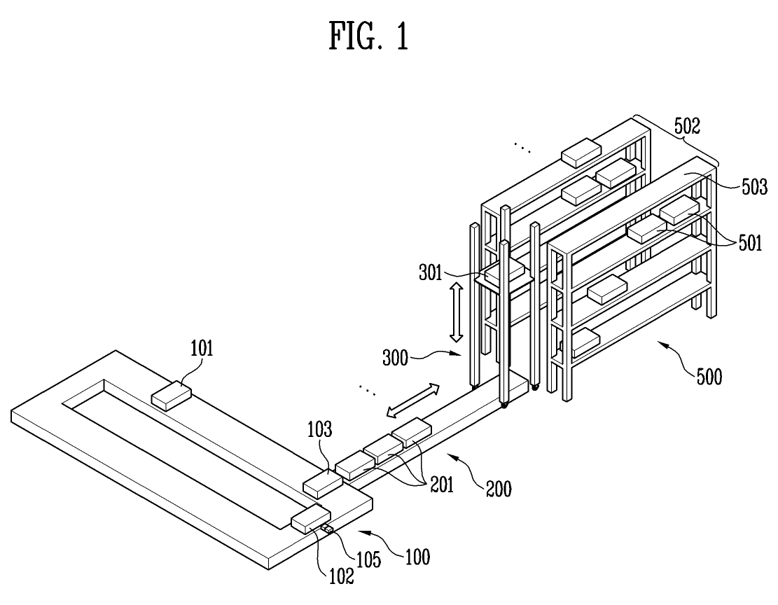

FIG. 1 is a schematic view of a warehouse system for implementing a method for storing a battery cell according to an embodiment of the present disclosure.

An embodiment of the present disclosure relates to a method for storing a battery cell, which is a method for storing a battery cell during an aging process of a battery cell, the method including: determining that a battery cell to be stored has arrived from a distribution conveyor carrying battery cells to a plurality of storages for storing the battery cell, the storages being arranged in rows and columns to form a plurality of lanes, respectively; transferring the arrived battery cell to a plurality of moorages arranged between each of the plurality of lanes and the distribution conveyor, and loading the battery cell; searching for a location of the battery cell being stored in the storage and an non-storage location; selecting, from the non-storage location, an intended storage location having a maximum movement distance along rows and columns of a transfer car for transferring the battery cell; and transferring the battery cell from the moorages to the intended storage location by the transfer car, and storing the battery cell.

For example, secondary batteries undergo an aging process to inject electrolyte and expel generated gases after assembling components. This aging process involves storing completed battery cells in a storage using a transfer car 300 and then, after a certain period of time, shipping them from the storage using the transfer car 300.

Meanwhile, the selecting of the intended storage location in the present disclosure may select the location among the non-storage locations where the transfer car has the maximum travel distance in terms of rows and columns for transferring the battery cells.

That is, even if the movement distance is closer, the storage with the maximum sum of rows or columns is searched first and the battery cells are stored there, and thus this maximizes the transfer car 300 movement time, thereby minimizing the impact on the flow of the overall distribution conveyor 100.

Therefore, by simply modifying the algorithm, battery cells can be stored in a way that minimizes the overall system load without replacing existing equipment.

Meanwhile, a management system (not shown) that manages the storage of battery cells may include, for example, a computer or server for managing and processing information related to the control of a distribution conveyor 100, the control of a moorage 200 and an additional moorage 400, the control of a transfer car 300, and a lift device 310.

Furthermore, the management system that manages the storage of battery cells may collect in real time information on battery cells 101 being distributed on the distribution conveyor 100, information on battery cells scheduled to arrive 102, information on arrived battery cells 103, information on moored battery cells 201, 401, information on battery cells 311 being moved up or down through the lift device 310, information on battery cells 301 being transferred by the transfer car 300, and information on battery cells 501 being stored, and may then process distribution, mooring, transfer, and storage through a program.

For example, information regarding the distribution, mooring, transfer, and storage of at least one battery cell 101, 102, 103, 201, 301, 401, 501 may be acquired through a scanner (e.g., image sensor, infrared sensor, barcode sensor, etc.) of at least one electronic device capable of communicating with the aforementioned management system.

For example, a management system that manages the storage of battery cells may include a control system that monitors the status and events of each transfer car 300 and lift device 310 and manages the movement of the transfer car 300 and lift device 310.

The control system for the transfer car 300 and lift device 310 may include at least one computer or server to monitor the status and events of each transfer car 300 and lift device 310, and control the transfer car 300 and lift device 310 according to preset objects of the transfer car 300 and lift device 310.

For example, the control system for the transfer car 300 and lift device 310 may receive information about the status and events of the transfer car 300 and lift device 310, and may also receive information from the control system regarding maps, stations, location groups, etc. of the space in which the transfer car 300 and lift device 310 operate.

For example, a management system that manages the storage of battery cells may include a server having hardware such as a memory, a communication interface, and a processor to manage the storage of battery cells according to various embodiments of the present disclosure.

For example, a memory is a configuration for storing at least one instruction or data related to the components of the server and an operating system (OS) for controlling the overall operation of server components. Furthermore, a memory may include a non-volatile memory such as ROM and flash memory, and a volatile memory such as DRAM. Furthermore, a memory may include a hard disk, a solid-state drive (SSD), etc. Furthermore, a memory may contain information about battery cells, as well as information about the real-time status, location, and station of the transfer car and lift device.

Meanwhile, a communication interface may include circuits, modules, chips, etc. for communicating with at least one external device (such as an external server or robot) via various wired or wireless communication schemes.

Furthermore, a communication interface may be connected to external devices via various networks. Depending on its scope and scale, a network may be a Personal Area Network (PAN), a Local Area Network (LAN), or a Wide Area Network (WAN), and depending on its openness, it may be the Intranet, the Extranet, or the Internet.

Furthermore, communication interfaces may connect to external devices via various wireless communication schemes, including long-term evolution (LTE), LTE Advance (LTE-A), 5th Generation (5G) mobile communications, code division multiple access (CDMA), wideband CDMA (WCDMA), universal mobile telecommunications system (UMTS), Wireless Broadband (WiBro), Global System for Mobile Communications (GSM), Time Division Multiple Access (DMA), WiFi (Wi-Fi), WiFi Direct, Bluetooth, near field communication (NFC), and Zigbee.

Furthermore, through the communication interface, the server may communicate directly or indirectly with various external systems (e.g., management systems, transfer car control systems, and lift device control systems). Furthermore, the server may communicate with one or more worker terminals through the communication interface.

Meanwhile, the processor is a component for overall control of the server. Specifically, the processor is connected to the memory and executes at least one instruction stored in the memory, thereby performing operations according to various embodiments of the present disclosure.

For example, the processor may include a versatile processor such as a CPU, AP, or DSP (Digital Signal Processor), a graphics-specific processor such as a GPU or VPU (Vision Processing Unit), or an AI-specific processor such as an NPU. The AI-specific processor may be designed with a hardware architecture specialized for training or utilizing a specific AI model.

For example, the moorage 200 may be positioned on the same plane as a portion of the distribution conveyor 100, and battery cells may be transferred from the distribution conveyor 100.

Furthermore, the moorage 200, in the form of a conveyor, may be used as a buffer when transferring battery cells from the distribution conveyor 100 to the storage 500. Therefore, since the moorage 200 functions as a storage buffer for the storage 500 of battery cells, even if the storage loading speed of the storage 500 fails to keep up with the distribution speed of the distribution conveyor 100, the problem of battery cell 101 distribution on the distribution conveyor 100 being stagnant can be prevented.

Meanwhile, in FIG. 1, only one lane 502 formed by a pair of storages 500 facing each other with respect to the horizontal movement direction of the transfer car 300 is illustrated, in which a moorage 200 according to an embodiment of the present disclosure is arranged so that a battery cell 201 is moored, and a battery cell 301 is transferred by one transfer car 300; however, it can be sufficiently understood by those skilled in the art that a plurality of second moorages, second transfer cars, second lanes, third moorages, third transfer cars, and third lanes may be arranged in parallel with the aforementioned moorage 200, transfer car 300, and lane 502.

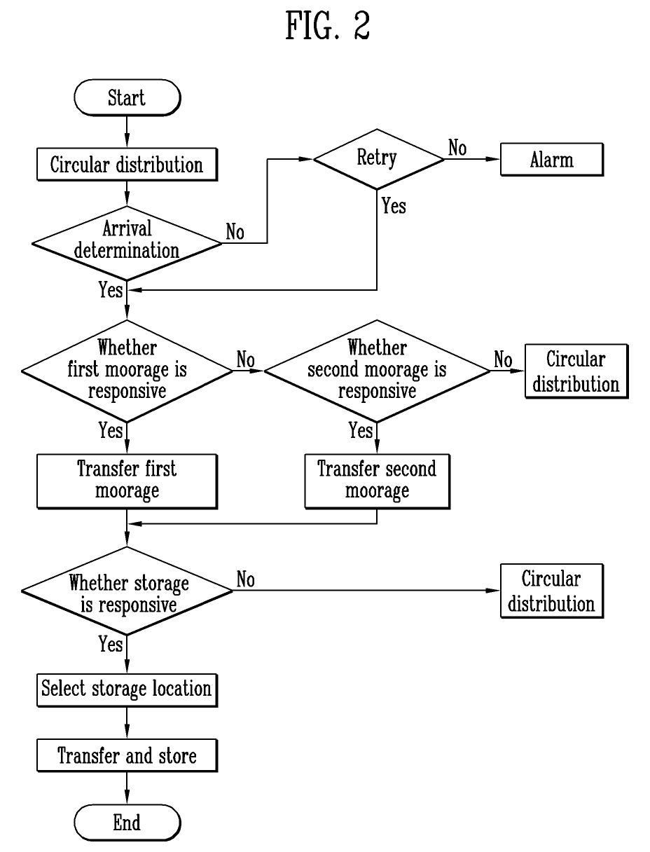

FIG. 2 is a flowchart illustrating the configuration of a method for storing a battery cell according to an embodiment of the present disclosure.

As illustrated in FIG. 2, in an embodiment of the present disclosure, a distribution conveyor 100 performs a "circular distribution" in which battery cells 101 circulate on a conveyor, and a sensor 105 may determine whether a battery cell scheduled for storage is scheduled to arrive at a predetermined location.

Meanwhile, if a battery cell scheduled to arrive 102 has arrived at a predetermined location but is not detected by the sensor 105, a retry for determination is performed and an alarm is issued to the operator.

Next, among a plurality of moorages arranged adjacent to the distribution conveyor 100, the number of battery cells 201 being moored at the first moorage closest to the battery cell detected as having arrived by the sensor 105 is determined to be moored to saturation, thereby determining whether the battery cell 103 arriving at the first moorage is responsive for transfer.

If the first moorage is determined to be responsive for the transfer of the arrived battery cell 103, the arrived battery cell 103 is transferred from the distribution conveyor 100 to the first moorage.

If the number of battery cells 201 being moored in the first moorage is determined to be moored to saturation, making it impossible to be responsive for the transfer of the arrived battery cell 103, it is determined whether the number of battery cells being moored in the second moorage (not shown), located next to the arrived battery cell 103 and parallel to the first moorage, is moored to saturation.

If the second moorage is determined to be responsive for the transfer of the arrived battery cell 103, the arrived battery cell 103 is transferred from the distribution conveyor 100 to the second moorage.

If the number of battery cells being moored in the second moorage is determined to be moored to saturation, making it impossible to transfer the arrived battery cells, the arrived battery cell 103 is not transferred to the second moorage, the distribution conveyor 100 is stopped for a predetermined period of time, for example, 30 seconds, and the mooring saturation of the first and second moorages is re-determined.

Meanwhile, the determining that the first or second moorage is moored to saturation may be set to, for example, 95% or more of the total number of battery cells that can be moored in the first or second moorage, and this can be adjusted based on the distribution speed of the distribution conveyor 100, the desired loading ratio of the storage 500 and moorage 200, and the transfer speed of the transfer car 300.

Furthermore, 30 seconds were exemplified for the aforementioned pause time of the distribution conveyor 100, but this can be adjusted based on the distribution speed of the distribution conveyor 100, the desired loading ratio of the storage 500 and moorage 200, and the transfer speed of the transfer car 300.

Furthermore, if the re-determination of whether the first and second moorages are moored to saturation is determined as mooring saturation, the arrived battery cell 103 is not transferred from the distribution conveyor 100 to the moorage 200, and a “circular distribution” is performed in which it is circulated on the distribution conveyor 100.

Next, if the first or second moorage is determined to be responsive and the battery cell is transferred to the first or second moorage, determining whether a plurality of storages 500 are storage-saturated may be further included to determine whether the storage 500 is responsive.

Additionally, if all of the multiple storages 500 are determined to be storage-saturated, the distribution conveyor 100 may stop for a predetermined period of time and then re-determine whether the plurality of storages 500 are storage-saturated.

For example, the criterion for determining that all of the plurality of storages 500 are storage-saturated may be set to 95% or more of the total number of battery cells that can be parked in the storages 500. This criterion can be adjusted based on the distribution speed of the distribution conveyor 100, the desired loading ratio of the storages 500 and the moorage 200, and the transfer speed of the transfer car 300.

Furthermore, 30 seconds were exemplified for the stop time of the distribution conveyor 100 due to storage-saturated storage 500, but this can be adjusted based on the distribution speed of the distribution conveyor 100, the desired loading ratio of the storages 500 and the moorage 200, and the transfer speed of the transfer car 300.

In addition, if the re-determination of whether the plurality of storages 500 are saturated is determined as saturation, the arrived battery cell 103 is not transferred from the distribution conveyor 100 to the moorage 200, and a “circular distribution” is performed in which it is circulated on the distribution conveyor 100.

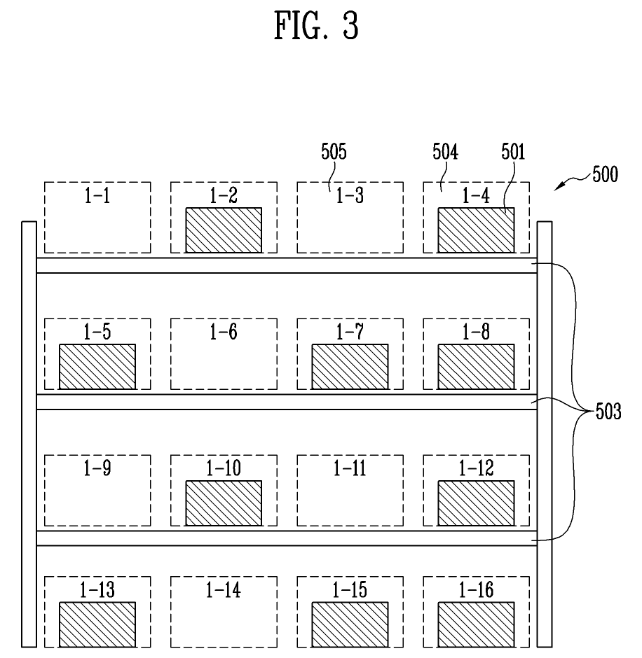

FIG. 3 is a schematic view illustrating the steps of creating a storage area in a storage 500 in which a method for storing a battery cell according to an embodiment of the present disclosure is implemented, and of selecting an intended storage location of the battery cell.

As illustrated in FIG. 3, the storage area of each storage may include multiple tiers, each tier having a plurality of shelves 503 containing the cells side by side.

Meanwhile, the storage area of each storage unit may further include a heating unit (not shown) that applies heat to the shelves 503 respectively housed in the tiers and the plurality of battery cells 501 contained in the shelves 503. To maximize the performance of battery cells, the battery cells must be left at a high temperature for a specific period of time, and at this time, a heater is required to create this high-temperature environment. The type of such heater need not be particularly limited and can be any device capable of transferring heat to each tray and battery cell via radiation.

Furthermore, the storage area of each storage may further include a detector (not shown) to detect overheating or ignition of the shelves 503 respectively housed in the tiers and the plurality of battery cells 501 contained in the shelves 503.

Furthermore, the storage area of each storage may further include a sensor (not shown) to acquire the location and information of the shelves 503 respectively housed in the tiers and the plurality of battery cells 501 contained in the shelves 503. Such a sensor may sense the weight corresponding to the battery cells 501 through a weight sensor of the battery cells 501, or sense the volume corresponding to the battery cells 501 through a camera or infrared sensor.

Through such a sensor, information about the currently stored battery cells 501 can be collected in real time, allowing the location 504 of the stored battery cells and the non-storage location 505 to be searched and categorized.

As described above, an embodiment of the present disclosure may select the intended storage location from the non-storage location 505 with the maximum movement distance of the transfer car 300 for transferring the battery cells 501 along the rows and columns.

For example, in FIG. 3, if, for the non-storage location area, a (1-1) area, a (1-9) area, and a (1-11) area are searched for, the storage area for the battery cells 501 can be selected as the (1-1) area because the selection is made under the condition that the sum of the rows and columns of each storage 500 is the maximum value. Accordingly, the transfer car 300 may transfer one of the battery cells 201 being moored in the moorage 200 to the (1-1) area to store it.

Meanwhile, transferring the battery cell 201 from the moorage 200 to the storage 500 may be performed by the transfer car 300. In an embodiment, the transfer car 300 may be moved by an operation in the horizontal and vertical directions.

Furthermore, in an embodiment of the present disclosure, the present disclosure may further include determining whether a plurality of storages 500 are storage-saturated. If all of the plurality of storages 500 are determined to be storage-saturated, the distribution conveyor 100 is stopped and waited for a predetermined period of time, and it may be re-determined whether the plurality of storages 500 are storage-saturated.

For example, during the process of collecting real-time information on battery cells 501 currently stored in the storage 500 and searching and classifying the location 504 of the stored battery cells and the non-storage location 505, if it is determined that there is no non-storage location 505, the distribution conveyor 100 may be stopped and waited for a predetermined period of time, for example, 30 seconds, and it may be re-determined whether the plurality of storages 500 are storage-saturated.

Meanwhile, in an embodiment of the present disclosure, the determining of the storage- saturated status may make a determination of the storage saturation status if the number of battery cells 501 that can be stored in the plurality of storages 500 is 95% or more compared to the total number of battery cells 501.

Furthermore, if the re-determination of whether the plurality of storages 500 are saturated is determined as saturation, a "circular distribution" may be performed, in which the arrived battery cell 103 is recirculated on the distribution conveyor instead of being transferred from the distribution conveyor 100 to the moorage 200.

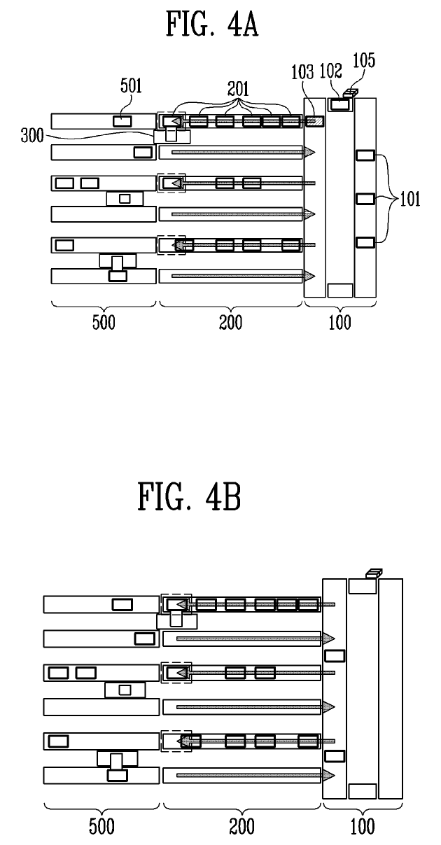

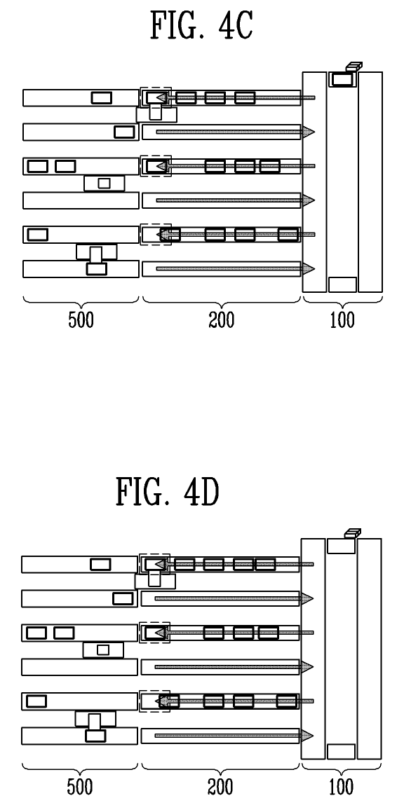

FIGS. 4A to 4D are each a schematic view illustrating a battery cell transfer process for implementing a method for storing a battery cell according to an embodiment of the present disclosure.

FIG. 4A illustrates a state where the moorage 200 is moored to saturation, meaning that the arrived battery cell 103 cannot be transferred to the first and second moorages. Therefore, as illustrated in FIG. 4B, after the distribution conveyor 100 stops for, for example, 30 seconds, a "circular distribution" of the arrived battery cell 103 is performed, allowing the battery cell 102 scheduled to arrive, circulated subsequently, to move normally.

Next, as illustrated in FIG. 4C, if the aforementioned scheduled-arrival battery cell 102 is determined to be capable of mooring at the second moorage, they may be transferred to the second moorage, and the aforementioned arrived battery cell 103 may be circulated and moved back to the intended arrival location. Next, if the re-arrived battery cell 103 is determined to be capable of being moored at the first moorage, as illustrated in FIG. 4D, it is transferred to the first moorage, thereby preventing battery cells from accumulating on the distribution conveyor 100 and enabling storage of all in the storage 500 through the moorage.

Therefore, in an embodiment of the present disclosure, the present disclosure continuously manages the transfer rate and loading rate of the distribution conveyor 100, moorage 200, transfer car 300, and storage 500 at appropriate levels, thereby preventing system downtime or errors in specific parts.

In addition, in an embodiment of the present disclosure, when all of the distribution conveyor 100, moorage 200, transfer car 300, and storage 500 are unable to be responsive, the distribution conveyor 100 may perform a “circular distribution” to prevent the flow of the distribution conveyor 100 from being blocked.

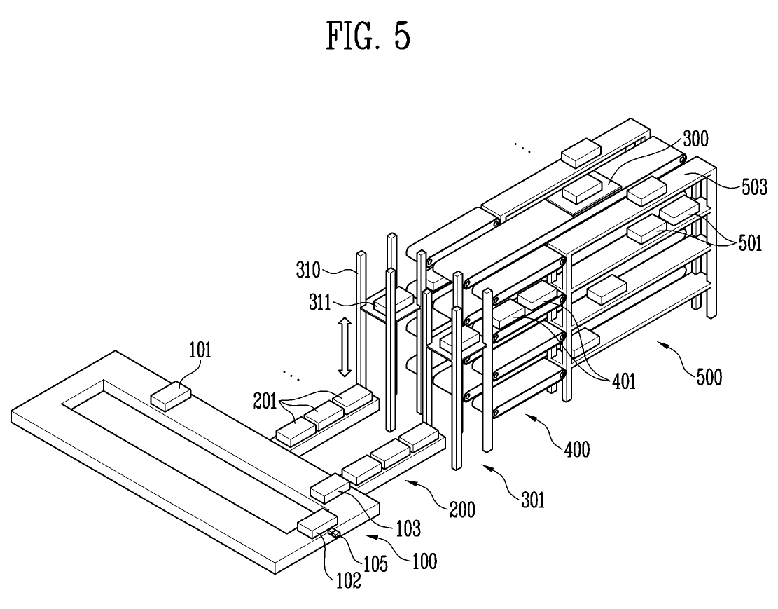

FIG. 5 is a schematic view of a warehouse system for implementing a method for storing a battery cell according to another embodiment of the present disclosure.

As illustrated in FIG. 5, another embodiment of the present disclosure may further include a plurality of lift devices 310 and a plurality of additional moorages 400 between a plurality of moorages 200 and a plurality of lanes 502.

Through the additional arrangement of the plurality of lift devices 310 and the plurality of additional moorages 400, the arrived battery cell 103 may be transferred in the order of the moorage 200, lift device 310, additional moorage 400, and transfer car 300, and ultimately transferred to the intended storage location in the storage 500 to be stored.

Meanwhile, since the vertical transfer of battery cells is performed by the lift device 310, such a transfer car 300 in another embodiment may be moved by an operation in the horizontal direction.

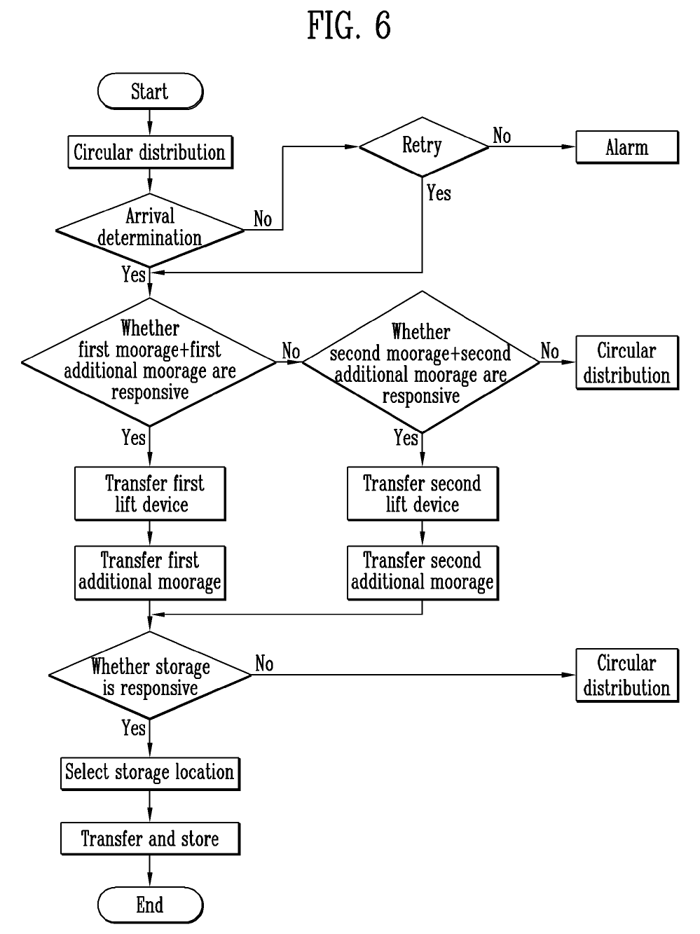

FIG. 6 is a flowchart illustrating the configuration of a method for storing a battery cell according to another embodiment of the present disclosure.

As illustrated in FIG. 6, another embodiment of the present disclosure may further include determining whether the additional moorage 400 is saturated, in addition to determining whether the moorage 200 is saturated.

For example, in another embodiment of the present disclosure, the determining of whether the moorage is saturated may be performed if the number of battery cells that can be moored in the plurality of moorages 200 and the plurality of additional moorages 400 is 95% or more compared to the total number of battery cells that can be moored in the plurality of moorages 200 and the plurality of additional moorages 400.

As described above, another embodiment of the present disclosure may include, if all of the plurality of moorages 200 and the plurality of additional moorages 400 are determined to be moored to saturation, stopping the distribution conveyor 100 for a predetermined period of time, for example, 30 seconds, and re-determining whether the plurality of moorages 200 and the plurality of additional moorages 400 are moored to saturation.

Meanwhile, the standard for determining that both the plurality of moorages 200 and the additional moorages 400 are moored to saturation may be set to 95% or more compared to the total number of battery cells that can be moored in the plurality of moorages 200 and the additional moorages 400, and may be adjusted according to the distribution speed of the distribution conveyor 100, the desired storage 500, the loading rate of the plurality of moorages 200 and the additional moorages 400, and the transfer speed of the transfer car 300 and the lift device 310.

In addition, 30 seconds were exemplified for the stop time of the distribution conveyor 100 due to the mooring saturation of the moorages 200 and additional moorages 400; however, this can be adjusted based on the distribution speed of the distribution conveyor 100, the desired storage 500, the loading ratio of the multiple moorages 200 and additional moorages 400, and the transfer speed of the transfer car 300 and lift device 310.

Furthermore, in another embodiment of the present disclosure, if the saturation of the moorages 200 and additional moorages 400 is re-determined as saturation, a “circular distribution” may be performed, in which the arrived battery cell 103 is circulated on the distribution conveyor without transferring the arrived battery cell 103 from the distribution conveyor 100 to the plurality of moorages 200.

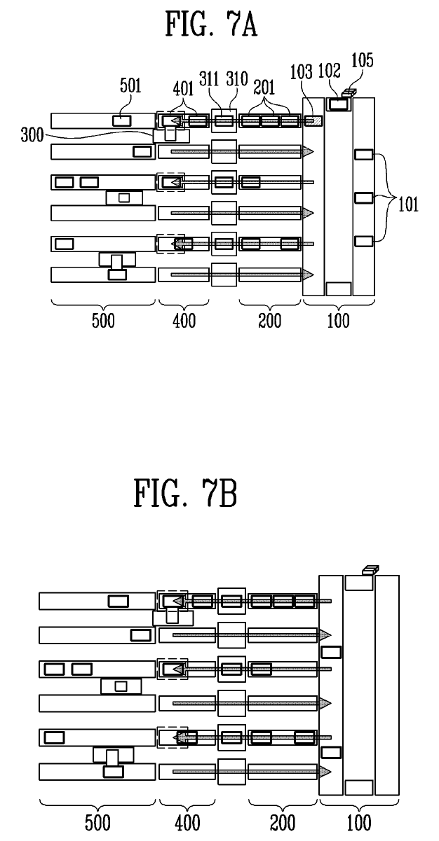

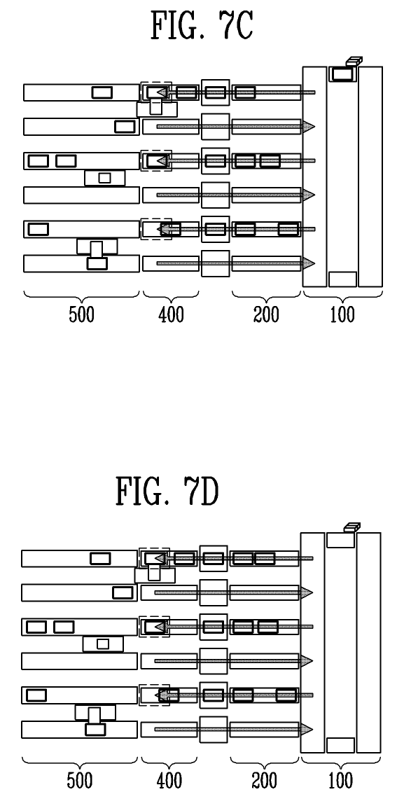

FIGS. 7A to 7D are each a schematic view for explaining a transfer process of a battery cell in which a method for storing a battery cell according to another embodiment of the present disclosure is implemented.

FIG. 7A illustrates a state where the moorages 200 and the additional moorages 400 are moored to saturation, indicating that the arrived battery cell 103 cannot be transferred to the first moorage, the second moorage, the first additional moorage, or the second additional moorage. Therefore, as illustrated in FIG. 7B, after the distribution conveyor 100 stops for, for example, 30 seconds, a "circular distribution" of the arrived battery cell 103 is performed, allowing the battery cell 102 scheduled to arrive, circulated subsequently, to move normally.

Next, as illustrated in FIG. 7C, if the aforementioned scheduled-arrival battery cell 102 is determined to be capable of being moored at the second moorage or the second additional moorage, it is transferred to the second moorage, and the aforementioned arrived battery cell 103 is circulated and moved back to the intended arrival location. Next, if the re-arrived battery cell 103 is determined to be capable of being moored at the first moorage or the first additional moorage, it is transferred to the first moorage, as illustrated in FIG. 7D. This prevents battery cells from stagnating on the distribution conveyor 100 and allows all of them to be stored in storage 500 through the moorage.

Therefore, in an embodiment of the present disclosure, the present disclosure continuously manages the transfer rate and loading rate of the distribution conveyor 100, moorage 200, additional moorage 400, transfer car 300, lift device 310, and storage 500 at appropriate levels, thereby preventing system downtime or errors in specific parts.

Furthermore, in an embodiment of the present disclosure, when all of the distribution conveyor 100, moorage 200, additional moorage 400, transfer car 300, lift device 310, and storage 500 are unable to be responsive, the distribution conveyor 100 may perform a “circular distribution” to prevent the flow of the distribution conveyor 100 from being blocked.

The scope of the present disclosure is defined by the claims below rather than the detailed description above, and all changes or modifications derived from the meaning and scope of the claims and their equivalents are to be construed as being included within the scope of the present disclosure.

What is claimed is:

1. A method for storing a battery cell during an aging process of the battery cell, the method comprising:
determining that a battery cell to be stored has arrived from a distribution conveyor carrying battery cells to a plurality of storages for storing the battery cell, the storages being arranged in rows and columns to form a plurality of lanes, respectively;
transferring the arrived battery cell to a plurality of moorages arranged between each of the plurality of lanes and the distribution conveyor, and loading the battery cell;
searching for a location of the battery cell being stored in the storage and a non-storage location;
selecting, from the non-storage location, an intended storage location having a maximum movement distance along rows and columns of a transfer car for transferring the battery cell; and
transferring the battery cell from the moorages to the intended storage location by the transfer car, and storing the battery cell.

2. The method of claim 1, wherein the selecting of the location having the maximum movement distance is selection with the condition that the sum of the number of rows and the number of columns of each storage is the maximum value.

3. The method of claim 2, further comprising, determining whether the number of battery cells moored in a first moorage closest to the arrived battery cell among the plurality of moorages is moored to saturation.

4. The method of claim 3, further comprising, if the number of battery cells in the first moorage is saturated, transferring the battery cell to a second moorage that is next closest to the arrived battery cells.

5. The method of claim 4, wherein the determining that the mooring is saturated is 95% or more compared to the total number of battery cells that can be moored in the first moorage.

6. The method of claim 5, wherein if all of the moorages are determined to be moored to saturation, the distribution conveyor stops for a predetermined period of time and it is re-determined whether the plurality of moorages are moored to saturation.

7. The method of claim 6, further comprising, if the re-determination of whether the plurality of moorages are moored to saturation is determined as mooring saturation, circulating the arrived battery cell on the distribution conveyor without transferring the arrived battery cell from the distribution conveyor to the plurality of moorages.

8. The method of claim 1, wherein the transfer car is moved by an operation in the horizontal and vertical directions.

9. The method of claim 1, wherein between the plurality of moorages and the plurality of lanes, a plurality of lift devices and a plurality of additional moorages are further included.

10. The method of claim 9, wherein the arrived battery cell is transferred in the order of the moorage, the lift device, the additional moorage, and the transfer car, and is transferred to the intended storage location of the storage and stored therein.

11. The method of claim 10, wherein the determining that the mooring is saturated is 95% or more compared to the total number of battery cells that can be moored in the plurality of moorages and the plurality of additional moorages.

12. The method of claim 11, wherein if both the plurality of moorages and the plurality of additional moorages are determined to be moored to saturation, the distribution conveyor stops for a predetermined period of time and it is re-determined whether the plurality of moorages and the plurality of additional moorages are moored to saturation.

13. The method of claim 12, further comprising, if the re-determination of whether the plurality of moorages and the plurality of additional moorages are moored to saturation is determined as mooring saturation, circulating the arrived battery cell on the distribution conveyor without transferring the arrived battery cell from the distribution conveyor to the plurality of moorages.

14. The method of claim 9, wherein the transfer car is moved by an operation in the horizontal direction.

15. The method of claim 14, further comprising, determining whether the plurality of storages are storage-saturated, wherein if all of the plurality of storages are determined to be storage-saturated, the distribution conveyor stops and waits for a predetermined period of time and it is re-determined whether the plurality of storages are storage-saturated.

16. The method of claim 15, wherein the determining of the storage saturation is 95% or more compared to the total number of battery cells that can be stored in the plurality of storages.

17. The method of claim 16, further comprising, if the re-determination of whether the plurality of storages are saturated is determined as saturation, circulating the arrived battery cell on the distribution conveyor without transferring the arrived battery cell from the distribution conveyor to the plurality of moorages.
